(19) United States
(12) Patent Application Publication
(10) Pub. No.: US 2007/0141409 A1
(43) Pub. Date: Jun. 21, 2007

(54) Fuel cell system and control method thereof

(75) Inventors: Tae-Hee Cho, Gyeongsangnam-Do (KR); Myung-Seok Park, Gyungsangnam-Do (KR); Hong Choi, Gyeongsangnam-Do (KR); Myeong-Ho Lee, Busan (KR); Kyu-Jung Kim, Gyeonggi-Do (KR); Cheol-Hwan Kim, Gimhae (KR); Yong-Jun Hwang, Gyeongsangnam-Do (KR); Seung-Tae Ko, Daegu (KR); Seong-Geun Heo, Busan (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 10/596,917

(22) PCT Filed: Dec. 30, 2003
(86) PCT No.: PCT/KR03/02904

§ 371 Date: Jun. 29, 2006

(51) Int. Cl. H01M 8/06; H01M 8/24; H01M 8/04

(52) U.S. Cl. 429/19; 429/38; 429/26; 429/24; 429/17

(57) ABSTRACT

Disclosed are a fuel cell system and a control method thereof. The fuel cell system comprises: a main fuel cell stack (6) that an anode (2) and a cathode (4) are arranged in a state that an electrolyte membrane is interposed therebetween; a fuel supplying unit connected with the anode of the main fuel cell stack (6) by a fuel supplying line (16) for supplying hydrogen-including fuel to the anode; an air supplying unit (10) connected to the cathode of the main fuel cell (6) stack by an air supplying line (20) for supplying oxygen-including air to the cathode (4); and a sub fuel cell stack (14) for using hydrogen generated at the anode (2) during reaction as fuel. According to this, energy efficiency of a fuel cell can be increased and danger due to exhaustion of hydrogen generated at the fuel cell stack (6) can be decreased.

### TECHNICAL FIELD

The present invention relates to a fuel cell system, and more particularly, to a fuel cell system capable of heating fuel and air by using hydrogen generated at a fuel cell stack after reaction and capable of being used as fuel of another fuel cell stack.

### BACKGROUND ART

In general, a fuel cell system has been proposed as a substitution of fossil fuel and differently from a general cell (a second cell), it supplies fuel (hydrogen or hydrocarbon) to an anode and supplies oxygen to a cathode. Thus, the fuel cell system undergoes an electrochemical reaction between hydrogen and oxygen without a combustion reaction (oxidation reaction) of fuel and thereby directly converts an energy difference between before and after a reaction into electric energy.

As shown in FIG. 1, a fuel cell system in accordance with the conventional art comprises a fuel cell stack 106 where an anode 102 and a cathode 104 having an electrolyte membrane (not shown) therebetween in order to generate electric energy by an electrochemical reaction between hydrogen and oxygen are stacked with the plural number, a fuel tank 108 for storing aqueous solution and NaBH₄ in order to supply BH₄ including hydrogen, substantially, NaBH₄ to the anode 102, and an air supplying unit 110 for supplying air including oxygen to the cathode 104.

A fuel pump 112 for pumping fuel stored in the fuel tank 108 is installed between the fuel tank 108 and the anode 102 of the fuel cell stack 106.

The air supplying unit 110 includes an air compressor 114 for supplying air in the atmosphere to the cathode 104 of the fuel cell stack 106, an air filter 116 for filtering air supplied to the fuel cell stack 106, and a humidifier 118 for humidifying air supplied to the fuel cell stack 106. The humidifier 118 is provided with a water tank 120 for supplying water to the humidifier 118.

Processes for generating electric energy by supplying fuel to the conventional fuel cell will be explained as follows.

When the fuel pump 112 is operated by a control signal of a controller (not shown), fuel stored in the fuel tank 108 is pumped thus to be supplied to the anode 102 of the fuel cell stack 106. Also, when the air compressor 114 is operated, air filtered by the air filter 116 passes through the humidifier 118 thus to be humidified and is supplied to the cathode 104 of the fuel cell stack 106.

Once fuel and air are supplied to the fuel cell stack 106, an electrochemical oxidation of hydrogen is performed in the anode 102 and an electrochemical deoxidation of oxygen is performed in the cathode 104 in a state that the electrolyte membrane (not shown) is positioned between the anode 102 and the cathode 104. At this time, generated electron moves and thereby electricity is generated. The generated electricity is supplied to a load 120.

In the conventional fuel cell system, temperature of fuel and air supplied to the fuel cell stack 106 greatly influences on a function of the fuel cell. Accordingly, an additional heating unit for increasing a temperature of fuel supplied to the anode 102 from the fuel tank 108 and a temperature of air supplied to the cathode 104 from the air supplying unit 110 to a constant level is provided.

However, in the conventional fuel cell system, an additional heating unit for heating fuel and air supplied to the fuel cell stack has to be provided and electric current generated at the fuel cell is used to operate the heating unit thus to increase a consumption power.

Additionally, in the conventional fuel cell system, hydrogen is generated at an electricity pole after reaction, which includes explosion danger in case that the hydrogen is emitted to outside.

### DISCLOSURE OF THE INVENTION

Therefore, it is an object of the present invention to provide a fuel cell system capable of enhancing energy efficiency of a fuel cell and reducing danger due to emission of hydrogen generated at a fuel cell stack by heating fuel and air with heat source of hydrogen generated after reaction at a fuel cell stack and by being used as fuel of another fuel cell stack.

To achieve these objects, there is provided a fuel cell system comprising: a main fuel cell stack that an anode and a cathode are arranged in a state that an electrolyte membrane is interposed therebetween; a fuel supplying unit connected with the anode of the main fuel cell stack by a fuel supplying line for supplying hydrogen-including fuel to the anode; an air supplying unit connected to the cathode of the main fuel cell stack by an air supplying line for supplying oxygen-including air to the cathode; and a sub fuel cell stack for using hydrogen generated at the anode during reaction as fuel.

The fuel cell system further comprises a gas/liquid separator for obtaining hydrogen generated at the main fuel cell stack after reaction, and a recycling line connected between the gas/liquid separator and the fuel supplying unit for recollecting fuel exhausted from the gas/liquid separator into a fuel tank.

A fuel cell system according to the present invention comprises: a main fuel cell stack that an anode and a cathode are arranged in a state that an electrolyte membrane is interposed therebetween; a fuel supplying unit connected with the anode of the main fuel cell stack by a fuel supplying line for supplying hydrogen-including fuel to the anode; an air supplying unit connected with the cathode of the main fuel cell stack by an air supplying line for supplying oxygen-including air to the cathode; a heating unit installed between the fuel supplying line and the air supplying line for heating fuel and air supplied to the main fuel cell stack by using hydrogen generated at the anode after reaction as a heat source; and a sub fuel cell stack for using hydrogen generated at the anode after reaction as fuel.

The fuel cell system further comprises a controller for maintaining a temperature of the heating unit as a proper level by controlling a hydrogen amount supplied to the sub fuel cell stack and for controlling an opening degree of an open/close valve in order to supply hydrogen to the sub fuel cell stack.

To achieve these objects, there is also provided a control method of a fuel cell system comprising: a first step of generating hydrogen from an anode of a main fuel cell stack after reaction; a second step of supplying hydrogen exhausted from the anode to a sub fuel cell stack; and a third step of controlling a hydrogen amount supplied to the sub fuel cell stack.

In the third step, when an electric signal is applied from a flow amount sensor which detects a hydrogen amount exhausted from the gas/liquid separator to the controller, the controller controls an opening degree of the open/close valve thus to control a hydrogen amount supplied to the sub fuel cell stack.

A control method of a fuel cell system according to the present invention comprises: a first step of generating hydrogen from an anode of a main fuel cell stack after reaction; a second step of supplying hydrogen exhausted from the anode to a heating unit and a sub fuel cell stack; and a third step of controlling a hydrogen amount supplied to the heating unit and the sub fuel cell stack according to a temperature of the heating unit.

In the third step, when a temperature of the heating unit is higher than a set temperature β, a hydrogen supply to the heating unit is shielded and hydrogen is supplied to the sub fuel cell stack, and when a temperature of the heating unit is lower than a set temperature a at the time of comparison in the above step, a hydrogen supply to the sub fuel cell stack is shielded and hydrogen is supplied to the heating unit.

### BRIEF DESCRIPTION OF THE DRAWINGS

FIG. 1 is a construction view of a fuel cell system in accordance with the conventional art;

FIG. 2 is a construction view of a fuel cell system according to a first embodiment of the present invention;

FIG. 3 is a partially cut perspective view of a heating unit of a fuel cell system according to a first embodiment of the present invention;

FIG. 4 is a block diagram showing a control means of a fuel cell system according to a first embodiment of the present invention;

FIG. 5 is a block diagram showing a control means of a fuel cell system according to a second embodiment of the present invention;

FIG. 6 is a block diagram showing a control means of a fuel cell system according to a third embodiment of the present invention;

FIG. 7 is a flow chart showing a control method of a fuel cell system according to one embodiment of the present invention; and

FIG. 8 is a flow chart showing a control method of a fuel cell system according to a second embodiment of the present invention.

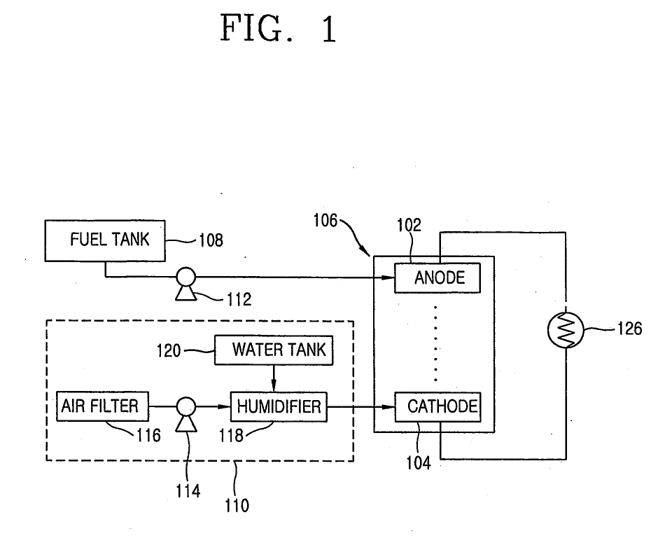

### MODES FOR CARRYING OUT THE PREFERRED EMBODIMENTS

Hereinafter, a first embodiment of a fuel cell system according to the present invention will be explained with reference to attached drawings.

Even if a plurality of embodiments can exist in the fuel cell system according to the present invention, the most preferable embodiment will be explained.

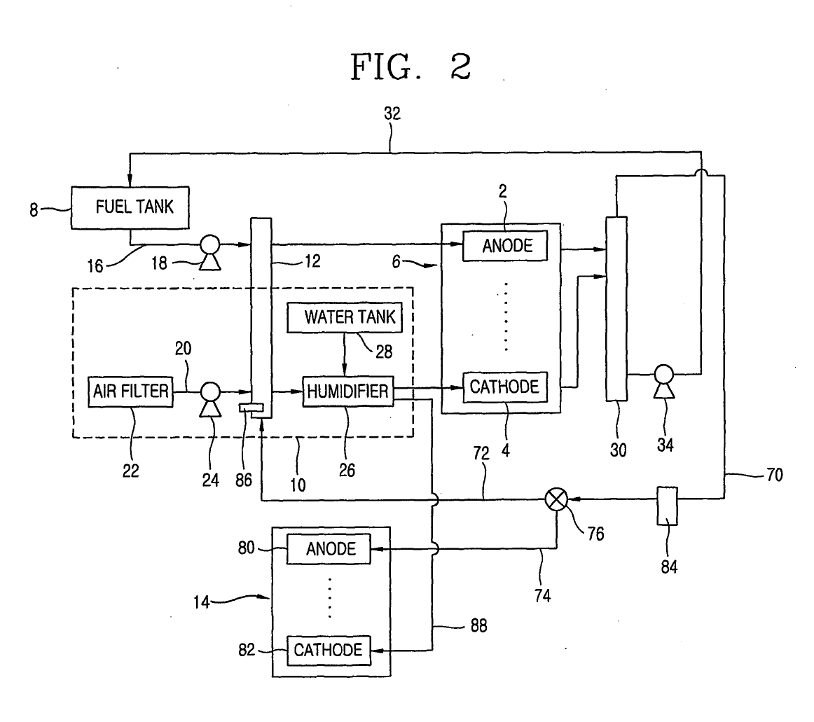

FIG. 2 is a construction view of a fuel cell system according to a first embodiment of the present invention.

A fuel cell system according to the present invention comprises: a main fuel cell stack 6 where an anode 2 and a cathode 4 are arranged in a state that an electrolyte membrane (not shown) is positioned therebetween in order to generate electric energy by an electrochemical reaction between hydrogen and oxygen are stacked with the plural number; a fuel tank 8 for storing fuel to be supplied to the anode 2; an air supplying unit 10 for supplying oxygen including air to the cathode 4; a fuel recycling unit for recycling fuel exhausted from the fuel cell stack 6 into the fuel tank 8; a heating unit 12 for heating fuel and air supplied to the main fuel cell stack 6 by using hydrogen generated at the anode 2 after reaction; and a sub fuel cell stack 14 for using hydrogen generated at the anode 2 after reaction as fuel.

In the fuel tank 8, NaBH₄ is stored. The fuel tank 8 is connected to the is anode 2 of the main fuel cell stack 6 by a fuel supplying line 16, and a fuel pump 18 for pumping fuel stored in the fuel tank 8 is installed at one side of the fuel supplying line 16.

The air supplying unit 10 includes an air supplying line 20 for introducing air in the atmosphere to the cathode 4 of the fuel cell stack 6, an air filter 22 installed at an entrance of the air supplying line 20 and filtering air sucked into the air supplying line 20, an air compressor 24 installed at one side of the air supplying line 20 and generating a suction power for sucking external air, and a humidifier 26 for humidifying air sucked by the air compressor 24. The humidifier 26 is provided with a water tank 28 for supplying water.

NaBH₄ and air including oxygen are respectively supplied to the anode 2 and the cathode 4 of the fuel cell stack 6 from the fuel tank 8 and the air supplying unit 10 and reacted with the electrolyte membrane thus to form ions. While the ions are electrochemically reacted thus to form water, electrons are generated and move to the cathode 4 thus to generate electricity.

This will be explained in more detail. In the anode 2, an electrochemical oxidation reaction BH₄⁻+8OH⁻->BO₂⁻+6H₂O+8e⁻ is performed thus to transmit ions generated from oxidation and deoxidatation reaction in the electrolyte membrane, and in the cathode 4, an electrochemical deoxidation reaction of the supplied air 2O₂+4H₂O+8e⁻->8OH⁻ is performed.

While these reactions are performed, a reaction such as 2H₂O+NaBH₄ ->NaBO₂+4H₂ is performed in the anode 2. According to this, 4H₂ is generated in the fuel (NaBH₄ aqueous solution) and is exhausted from the anode 2 with NaBO₂.

The fuel recycling unit is a system for recollecting fuel exhausted after reaction in the fuel cell stack 6 into the fuel tank 8, and includes a gas/liquid separator 30 for separating fuel exhausted after reaction in the main fuel cell stack 6 into gas and liquid, a fuel recycling line 32 for recollecting fuel of a liquid state exhausted from the gasaiquid separator 30 into the fuel tank 8, and a recycling pump 34 installed at the fuel recycling line 32 for pumping recollected liquid fuel to the fuel tank 8.

The NaBO₂+4H₂ generated after reaction in the anode 2 of the fuel cell stack 6 is divided into gas and liquid by the gas/liquid separator 30. As the result, water and NaBO₂ are recollected at the fuel tank 8 through the fuel recycling line 32, whereas hydrogen is exhausted outside.

Like this, hydrogen exhausted from the gas/liquid separator 30 is used as a heat source of the heating unit 12 and is used as fuel of the sub fuel cell stack 14. Also, an amount of hydrogen supplied to the heating unit 12 and the sub fuel cell stack 14 is controlled by a control means.

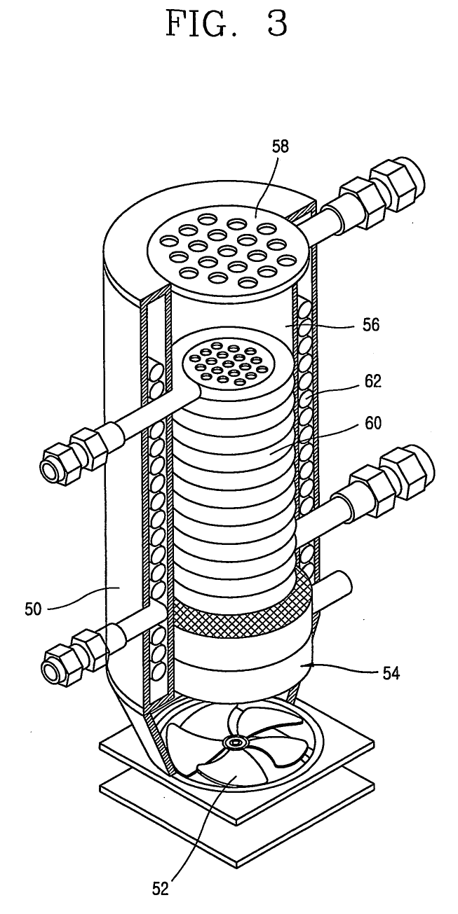

As shown in FIG. 3, the heating unit 12 is constituted with the fuel supplying line 16, a housing 50 to which the air supplying line 20 is connected, a blast fan 52 installed at a lower portion of the housing 50 and blowing external air to inside of the housing 50, and a combustor 54 installed at an inner portion of the housing 50 and reacted with hydrogen supplied from the gasaiquid separator 30 thus to generate heat for heating fuel and air which pass through inside of the housing 50.

A division wall 56 of a cylindrical shape having a diameter smaller than that of the housing 50 is arranged in the housing 50 with a constant interval from an inner circumferential surface of the housing 50. A plurality of exhaustion holes 58 for exhausting gas which has finished a heating performance to outside are formed at an upper portion of the housing 50, and the combustor 54 and the blast fan 52 are installed at an upper portion thereof.

A fuel pipe 60 for passing fuel is wound as a coil shape inside the division wall 56, and an air pipe 62 for passing air is wound as a coil shape outside the division wall 56.

The combustor 54 is mounted at a lower portion of the housing 50 and is formed as a honeycomb shape to inside of which a catalyst is attached. The combustor 54 is connected to the gas/liquid separator 30 by a first hydrogen supplying line 72 thus to receive hydrogen exhausted from the gas/liquid separator 30. Herein, as said catalyst, platinum is preferably used.

Air blown to inside of the housing 50 is heated by the heat generation inside of the combustor 54, and the heated air passes through inside of the housing 50 thus to heat the fuel pipe 60 and the air pipe 62. Also, air which has finished the heating performance is exhausted to outside through the exhaustion holes 58.

In the sub fuel cell stack 14, an anode 80 to which hydrogen generated at the anode 2 of the main fuel cell stack 6 after reaction is supplied and a cathode 82 connected to the air supplying unit 10 and to which air including oxygen is supplied are stacked with the plural number in a state that an electrolyte membrane is interposed therebetween.

The anode 80 of the sub fuel cell stack 14 is connected to the gas/liquid separator 30 by a hydrogen supplying line 74 thus to receive hydrogen exhausted from the gas/liquid separator 30. Also, the cathode 82 is connected to the humidifier 26 of the air supplying unit 10 by an air supplying line 88 thus to receive humidified air.

As the sub fuel cell stack 14 of the preferred embodiment, a polymer electrolyte membrane fuel cell PEMFC in which hydrogen is used as fuel is preferably applied.

In the sub fuel cell stack 14, hydrogen exhausted from the gas/liquid separator 30 is supplied to the anode 80. Under this state, when air including oxygen is supplied to the anode 82 from the air supplying unit 10, the hydrogen and oxygen react reciprocally and thereby the sub fuel cell stack 14 generates electric energy separately from the main fuel cell stack 6.

A hydrogen exhausting line 70 for exhausting hydrogen is connected to the gas/liquid separator 30, and the hydrogen exhausting line 70 is diverged into a first hydrogen supplying line 72 connected to the heating unit 12 and a second hydrogen supplying line 74 connected to the anode 80 of the sub fuel cell stack 14. An open/close valve 76 is installed at a part where the hydrogen exhausting line 70 and the first and second hydrogen supplying lines are connected each other.

The open/close valve 76 connects the hydrogen exhausting line and the first hydrogen supplying line 72 or the second hydrogen supplying line 74 according to an electric signal applied from a controller 90, thereby supplying hydrogen to the heating unit 12 or the sub fuel cell stack 14.

As the open/close valve 76, a needle valve capable of easily controlling an opening degree thereof by an electric signal applied from the controller 90 is preferably used.

In the fuel cell system, the controller 90 maintains a temperature of the heating unit 12 as a proper level by controlling a hydrogen amount supplied to the heating unit 12 and the sub fuel cell stack 14, and controls an opening degree of the open/close valve 76 in order to supply hydrogen to the sub fuel cell stack 14.

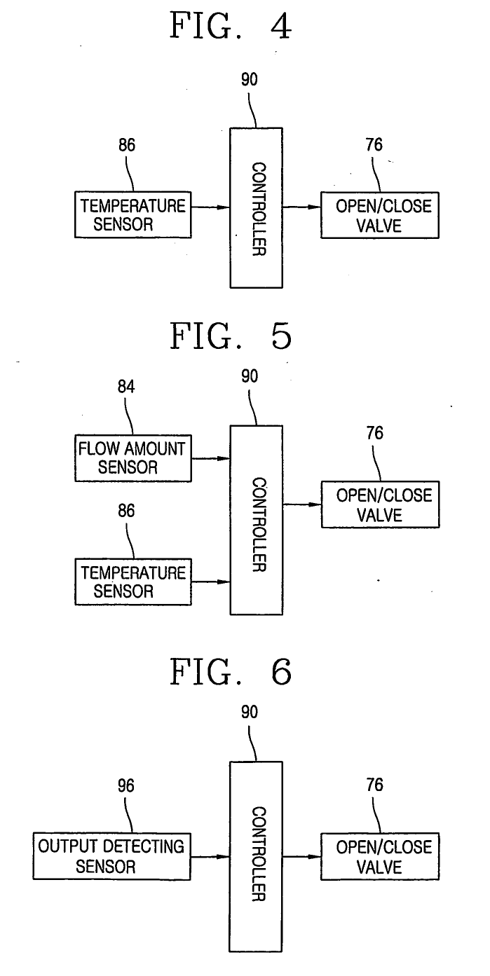

As one embodiment, as shown in FIG. 4, the controller 90 controls an opening degree of the open/close valve 76 according to an electric signal applied from a temperature sensor 86 installed at the heating unit 12 for detecting a temperature of the heating unit 12.

The temperature sensor 86 can be installed at a catalyst mounted in the combustor 54 in order to detect a temperature of the combustor 54 of the heating unit 12, can be installed at an air pipe 62 in order to detect a temperature of air heated in the heating unit 12, and can be installed at the fuel pipe 60 in order to detect a temperature of fuel heated in the heating unit. That is, the temperature sensor 86 can set one of catalyst, air, and fuel as a set temperature.

As shown in FIG. 5, as another embodiment, the controller 90 controls an opening degree of the open/close valve 76 according to an electric signal applied from a flow amount sensor 84 installed at the hydrogen exhausting line 70 for detecting a hydrogen amount and the temperature is sensor 86 installed at the heating unit 12 for detecting a temperature of the heating unit 12.

As still another embodiment, as shown in FIG. 6, the controller can control an opening degree of the open/close valve 76 according to an electric signal applied from an output detecting sensor 96 for detecting an output of the sub fuel cell stack.

A control method of the fuel cell system according to the first embodiment of the present invention will be explained as follows.

First, hydrogen is generated at the anode 2 of the main fuel cell stack 6 after reaction. Then, hydrogen from the anode 2 of the main fuel cell stack 6 by the aforementioned method is supplied to the sub fuel cell stack 14.

Then, a hydrogen amount supplied to the sub fuel cell stack 14 is controlled. That is, once an electrical signal is applied to the controller 90 from the flow amount sensor 84 for detecting a hydrogen amount exhausted from the gas/liquid separator 30, the controller 90 controls an opening degree of the open/close valve 76 thus to control a hydrogen amount supplied to the sub fuel cell stack 14.

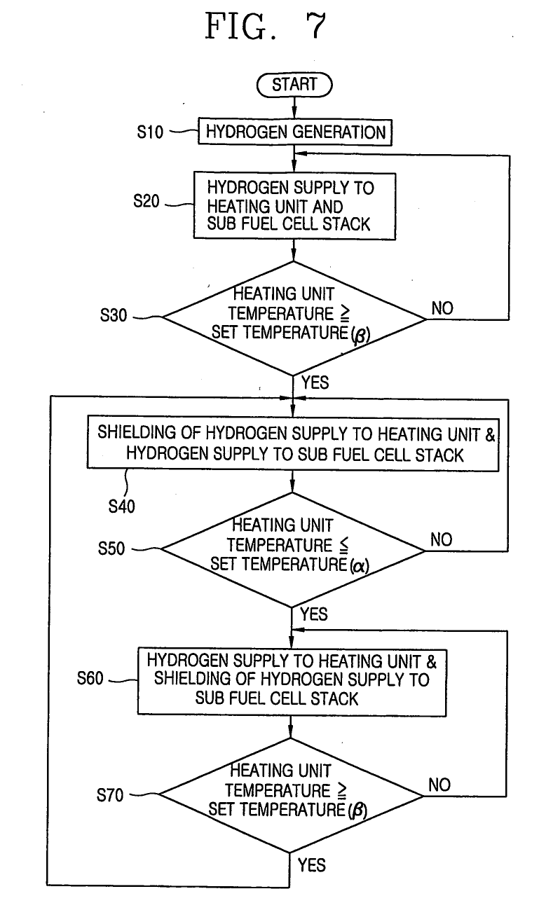

FIG. 7 is a flow chart showing a control method of the fuel cell system according to the third embodiment of the present invention.

First, hydrogen is exhausted from the anode 2 of the main fuel cell stack 6 (S10). That is, hydrogen generated at the anode 2 of the main fuel cell stack 6 is extracted through the gas/liquid separator 30 thus to be supplied to the hydrogen exhausting line 70.

The hydrogen exhausted from the gas/liquid separator 30 is supplied to the heating unit 12 thus to be used as a heating source of the heating unit 12 and at the same time is supplied to the sub fuel cell stack 14 thus to be used as fuel (S20). That is, an opening degree of the open/close valve 76 is controlled thus to simultaneously open a flow channel between the gas/liquid separator 30 and the heating unit 12 and a flow channel between the gas/liquid separator 30 and the sub fuel cell stack 14, thereby simultaneously supplying hydrogen exhausted from the gasaiquid separator 30 to the heating unit 12 and the sub fuel cell stack 14.

Then, a temperature of the heating unit 12 is compared with a set temperature β(S30). That is, in the process that fuel and air are heated by the heating unit 12, when the temperature sensor 86 detects one temperature among fuel, air, and catalyst and thus applies to the controller 90, the controller 90 compares a temperature of the heating unit 12 applied from the temperature sensor 86 with the set temperature βand judges that the temperature of the heating unit 12 is higher than the set temperature β. The set temperature βis preferably set as 80° C. in case of detecting temperature of heated fuel or air.

In said process, when it is judged that a temperature of the heating unit 12 is higher than the set temperature β, a hydrogen supply to the heating unit 12 is shielded and hydrogen is supplied to the anode 80 of the sub fuel cell stack 14 (S40). That is, when it is judged that the temperature of the heating unit 12 applied from the temperature sensor 86 is higher than the set temperature β, the controller 90 operates the open/close valve 76 thus to close between the first flow channel 70 and the second flow channel 72 and to connect the first flow channel 70 and the third flow channel 74. Then, the hydrogen supply to the heating unit 12 is shielded, and hydrogen is supplied to the anode 80 of the sub fuel cell stack 14 thus to be used as fuel.

During this operation, a temperature of the heating unit 12 is compared with a set temperature α. When the temperature of the heating unit 12 is judged to be lower than the set temperature α, hydrogen supply to the sub fuel cell stack 14 is shielded and hydrogen is supplied to the heating unit 12 (S50 and S60).

That is, when the temperature sensor 86 detects a temperature of the heating unit 12 thus to apply to the controller 90, the controller 90 compares the temperature of the heating unit 12 with the set temperature α. At this time, when the temperature of the heating unit 12 is judged to be lower than the set temperature α, the controller 90 controls the open/close valve 76 thus to close between the first flow channel 70 and the third flow channel 74 and to connect the first flow channel 70 and the second flow channel 72. Accordingly, hydrogen supply to the sub fuel cell stack 14 is shielded and hydrogen is supplied to the heating unit 12.

The set temperature a is preferably set as 60° C. in case of detecting temperature of heated fuel or air.

During this heating performance, when it is judged that a temperature of the heating unit 12 is higher than the set temperature β, hydrogen supply to the heating unit 12 is again shielded and hydrogen is supplied to the sub fuel cell stack 14, which is repeated (S70).

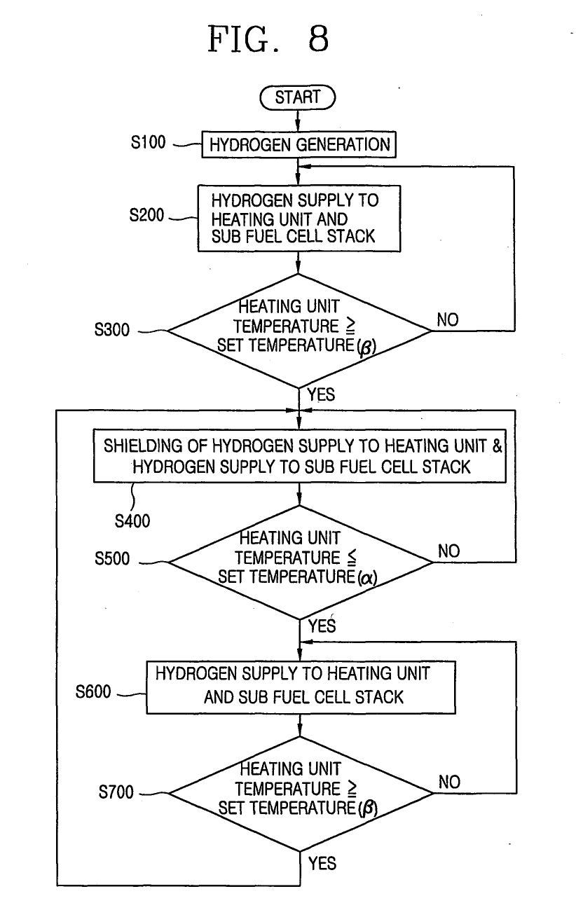

FIG. 8 is a block diagram showing a control method of the fuel cell system according to the third embodiment of the present invention.

First, hydrogen is exhausted from the gas/liquid separator 30 (S100). Hydrogen exhausted from the gas/liquid separator 30 is supplied to the heating unit 12 thus to be used as a heating source of the heating unit 12 and at the same time is supplied to the sub fuel cell stack 14 thus to be used as fuel (S200). That is, an opening degree of the open/close valve 76 is controlled thus to simultaneously open a flow channel between the gas/liquid separator 30 and the heating unit 12 and a flow channel between the gas/liquid separator 30 and the sub fuel cell stack 14, thereby simultaneously supplying hydrogen exhausted from the gas/liquid separator 30 to the heating unit 12 and the sub fuel cell stack 14.

Then, a temperature of the heating unit 12 is compared with a set temperature (S300), and hydrogen supply to the heating unit 12 is shielded and hydrogen is supplied to the sub fuel cell stack 14 when the temperature of the heating unit 12 is judged to be higher than the set temperature β, (S400). Said steps are equal to those of the first embodiment, so that the explanations will be omitted.

Under said state, a temperature of the heating unit 12 is compared with a set temperature α(S500). When the temperature of the heating unit 12 is judged to be lower than the set temperature α, hydrogen supply to the sub fuel cell stack 14 is continuously performed and hydrogen is supplied to the heating unit 12 (S600).

That is, when the temperature sensor 86 detects a temperature of the heating unit 12 thus to apply to the controller 90 and the flow amount sensor 84 detects hydrogen amount exhausted from the gas/liquid separator 30 thus to apply to the controller 90, the controller 90 compares the temperature of the heating unit 12 with the set temperature α. At this time, when the temperature of the heating unit 12 is judged to be lower than the set temperature α, the controller 90 judges hydrogen amount exhausted from the gasaiquid separator 30 by an electric signal applied from the flow amount sensor 84. Then, the controller 90 controls hydrogen amount supplied to the heating unit 12 and hydrogen amount supplied to the sub fuel cell stack 14 by controlling an opening degree of the open/close valve 76. According to this, hydrogen of a certain amount is supplied to the heating unit 12 thus to be used as a heat source and is supplied to the sub fuel cell stack 14 thus to be used as fuel.

When a temperature of the heating unit 12 is higher than the set temperature β, during the heating process and the electric energy generation process, hydrogen supply to the heating unit 12 is shielded and hydrogen is continuously supplied to the sub fuel cell stack 14, which is repeated (S700).

According to the fuel cell system according to the present invention, fuel and air supplied to the fuel cell stack are heated by using hydrogen generated at the anode after reaction, so that an additional power for heating fuel and air is not required thus to enhance a performance of the fuel cell system. Also, hydrogen generated from the anode is used as an additional fuel of the fuel cell stack thus to increase energy efficiency of the fuel cell.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A fuel cell system comprising:
a main fuel cell stack that an anode and a cathode are arranged in a state that an electrolyte membrane is interposed therebetween;
a fuel supplying unit connected with the anode of the main fuel cell stack by a fuel supplying line for supplying hydrogen-including fuel to the anode;
an air supplying unit connected to the cathode of the main fuel cell stack by an air supplying line for supplying oxygen-including air to the cathode; and
a sub fuel cell stack for using hydrogen generated at the anode during reaction as fuel.

2. The fuel cell system of claim 1 further comprising:
a gas/liquid separator for obtaining hydrogen generated at the main fuel cell stack after reaction; and
a recycling line connected between the gas/liquid separator and the fuel supplying unit for recollecting fuel exhausted from the gas/liquid separator into a fuel tank.

3. The fuel cell system of claim 1, wherein fuel stored in the fuel tank is aqueous solution of NaBH₄.

4. The fuel cell system of claim 2, wherein the sub fuel cell stack is a polymer electrolyte membrane fuel cell (PEMFC).

5. The fuel cell system of claim 4, wherein the sub fuel cell stack is constituted in accordance with that a cathode to which oxygen including air is supplied from the air supplying unit and an anode to which hydrogen generated at the anode of the main fuel cell stack after reaction are stacked in a state that an electrolyte membrane is interposed therebetween.

6. A fuel cell system comprising:
a main fuel cell stack that an anode and a cathode are arranged in a state that an electrolyte membrane is interposed therebetween;
a fuel supplying unit connected with the anode of the main fuel cell stack by a fuel supplying line for supplying hydrogen-including fuel to the anode;
an air supplying unit connected to the cathode of the main fuel cell stack by an air supplying line for supplying oxygen-including air to the cathode;
a heating unit installed between the fuel supplying line and the air supplying line for heating fuel and air supplied to the main fuel cell stack by using hydrogen generated at the anode after reaction as a heating; and
a sub fuel cell stack for using hydrogen generated at the anode during reaction as fuel.

7. The fuel cell system of claim 6 further comprising:
a gas/liquid separator for obtaining hydrogen generated at the main fuel cell stack after reaction; and
a recycling line connected between the gas/liquid separator and the fuel supplying unit for recollecting fuel exhausted from the gas/liquid separator into a fuel tank.

8. The fuel cell system of claim 7, wherein an open/close valve for selectively opening either a flow channel connecting the heating unit and the gas/liquid separator or a flow channel connecting the sub fuel cell stack and the gas/iquid separator is installed between said two flow channels.

9. The fuel cell system of claim 8 further comprising a controller for maintaining a temperature of the heating unit as a proper level by controlling a hydrogen amount supplied to the sub fuel cell stack and for controlling an opening degree of an open/close valve in order to supply hydrogen to the sub fuel cell stack.

10. The fuel cell system of claim 9, wherein the controller controls an opening degree of the open/close valve according to an electric signal applied from a temperature sensor installed at the heating unit for detecting a temperature of the heating unit.

11. The fuel cell system of claim 10, wherein the temperature sensor is installed at one of a heat generating part, a fuel pipe, and an air pipe of the heating unit.

12. The fuel cell system of claim 9, wherein the controller controls an opening degree of the open/close valve according to an output of the sub fuel cell stack.

13. The fuel cell system of claim 9, wherein the controller controls an opening degree of the open/close valve according to an electric signal applied from a flow amount sensor installed at the hydrogen exhausting line for detecting a hydrogen amount and the temperature sensor installed at the heating unit for detecting a temperature of the heating unit.

14. The fuel cell system of claim 7, wherein the heating unit comprises:
a housing to which a fuel pipe for passing fuel supplied to the anode of the main fuel cell stack and an air pipe for passing air supplied to the cathode are respectively mounted;
a blast fan installed at the housing for blowing external air to inside of the housing; and
a combustor at inside of which a catalyst is mounted and to which oxygen including air blown by the blast fan and hydrogen exhausted from the gas/liquid separator are respectively introduced.

15. The fuel cell system of claim 6, wherein fuel stored in the fuel tank is aqueous solution of NaBH₄.

16. The fuel cell system of claim 6, wherein the sub fuel cell stack is a polymer electrolyte membrane fuel cell (PEMFC).

17. The fuel cell system of claim 7, wherein the sub fuel cell stack is constituted in accordance with that a cathode to which oxygen including air is supplied from the air supplying unit and an anode to which hydrogen exhausted from the gas/liquid separator are stacked in a state that an electrolyte membrane is positioned therebetween.

18. A control method of a fuel cell system comprising:
a first step of generating hydrogen from an anode of a main fuel cell is stack after reaction;
a second step of supplying hydrogen exhausted from the anode to a sub fuel cell stack; and
a third step of controlling a hydrogen amount supplied to the sub fuel cell stack.

19. The method of claim 18, wherein a controller controls an opening degree of an open/close valve thus to control a hydrogen amount supplied to the sub fuel cell stack when an electric signal is applied from a flow amount sensor which detects a hydrogen amount exhausted from a gas/liquid separator to the controller in the third step.

20. A control method of a fuel cell system comprising:
a first step of generating hydrogen from an anode of a main fuel cell stack after reaction;
a second step of supplying hydrogen exhausted from the anode to a heating unit and a sub fuel cell stack; and
a third step of controlling a hydrogen amount supplied to the heating unit and the sub fuel cell stack according to a temperature of the heating unit.

21. The method of claim 20, wherein a controller compares a temperature of the heating unit with a set temperature thus to control an opening degree of an open/close valve when a temperature sensor installed at the heating unit detects one temperature of fuel, air, and catalyst thus to apply to the controller in the third step.

22. The method of claim 20, wherein the third step comprises the steps of:
shielding hydrogen supply to the heating unit and supplying hydrogen to the sub fuel cell stack when a temperature of the heating unit is higher than a set temperature β; and
shielding hydrogen supply to the sub fuel cell stack and supplying hydrogen to the heating unit when the temperature of the heating unit is lower than a set temperature a at the time of comparison between the temperature of the heating unit and the set temperature a in the above step.

23. The method of claim 20, wherein the third step comprises the steps of:
shielding hydrogen supply to the heating unit and supplying hydrogen to the sub fuel cell stack when a temperature of the heating unit is higher than a set temperature β; and
continuously supplying hydrogen to the sub fuel cell stack and supplying hydrogen to the heating unit when the temperature of the heating unit is lower than a set temperature αat the time of comparison between the temperature of the heating unit and the set temperature αin the above step.

24. A control method of a fuel cell system comprising:
a first step of generating hydrogen from an anode of a main fuel cell stack after reaction;
a second step of supplying hydrogen exhausted from the anode to a heating unit and a sub fuel cell stack; and
a third step of controlling a hydrogen amount supplied to the heating unit and the sub fuel cell stack according to a current amount outputted from the sub fuel cell stack.

25. The method of claim 24, wherein the controller controls an opening degree of an open/close valve by comparing a current amount outputted form the sub fuel cell stack with a set value.

26. A control method of a fuel cell system comprising:
a first step of generating hydrogen from an anode of a main fuel cell stack after reaction;
a second step of supplying hydrogen exhausted from the anode to a heating unit and a sub fuel cell stack; and
a third step of controlling a hydrogen amount supplied to the heating unit and the sub fuel cell stack according to a temperature of the heating unit and a hydrogen amount exhausted from the anode.

27. The method of claim 26, wherein a controller controls an opening degree of an open/close valve by judging a hydrogen amount exhausted from a gas/liquid separator according to an electric signal applied from a flow amount sensor thus to control a hydrogen amount supplied to the heating unit and the sub fuel cell stack when the flow amount sensor detects a hydrogen amount exhausted from the gas/liquid separator thus to apply to the controller in the third step.
